(19) United States
(12) Patent Application Publication
(10) Pub. No.: US 2006/0253476 A1
(43) Pub. Date: Nov. 9, 2006

(54) Technique for relationship discovery in schemas using semantic name indexing

(76) Inventors: Mary Ann Roth, San Jose, CA (US); Tanveer Fathima Syeda-Mahmood, Cupertino, CA (US); Lingling Yan, San Jose, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/126,125

(22) Filed: May 9, 2005

(51) Int. Cl. G06F 7/00

(52) U.S. Cl. 707/100

(57) ABSTRACT

Techniques are provided for semantic matching. A semantic index is created for one or more schemas, wherein each of the one or more schemas includes one or more word attributes, and wherein each of the one or more word attributes includes one or more tokens, wherein the semantic index identifies one or more keys and one or more values for each key, wherein each value specifies one of the one or more schemas, a word attribute from the specified schema, and a token of the specified word attribute, and wherein the specified token is a synonym of the key. For a source word attribute from one of the one or more schemas, the source word attribute is used as a key to index the semantic index to identify one or more matching word attributes.

### BACKGROUND

1. Field

Embodiments of the invention relate to relationship discovery in schemas using semantic name indexing.

2. Description of the Related Art

Extensible Markup Language (XML) is becoming a de facto standard for representing structured metadata in databases and internet applications. XML contains markup symbols to describe the contents of a document in terms of what data is being described, and an XML document may be processed as data by a program. An XML schema may be described as a mechanism for describing and constraining the content of XML files by indicating which elements are allowed and in which combinations. Semantically-related schemas may be described as those schemas in which a large number of attributes are related either by name, structure or type information.

It is now possible to express several kinds of metadata, such as relational schemas, business objects, or web services through XML schemas. A relational schema may be described as a collection of database objects, such as tables, views, indexes, or triggers that define a database, and the database schema may be described as providing a logical classification of database objects. A business object may be described as a set of attributes that represent a business entity (e.g., Employee), an action on the data (e.g., a create or update operation), and instructions for processing the data. A web service may be described as a service provided on the World Wide Web (“web”). An XML schema may be described as representing the interrelationships between attributes and elements of an XML object. As XML starts to be used more ubiquitously in the industry, large metadata repositories are being constructed ranging from business object repositories (e.g., Universal Description, Discovery, and Interaction (UDDI)), to general metadata repositories. UDDI may be described as an XML-based registry for businesses worldwide to list themselves on the Internet.

Schema matching lies at the heart of numerous data management applications. Virtually any application that manipulates data in different schema formats establishes semantic mappings between the schemas, to ensure interoperability. Prime examples of such applications arise in data integration, data warehousing, data mining, e-commerce, bio-informatics, knowledge-base construction, and information processing on the Internet. Today, schema matching is still mainly conducted by hand, in a labor-intensive and error-prone process. The prohibitive cost of schema matching has now become a key bottleneck in the deployment of a wide variety of data management applications.

Enabling schema matching requires a key problem to be solved, namely, the correspondence between schema attributes. The problem of finding correspondences in schemas is a difficult problem. Since the schemas of the data sources in such architectures are independently designed, it is inevitable that there are differences between them. These differences can range from differences in the naming of elements, choice of different normalizations, different data models, etc. In addition, type and structural difference may be present in different schemas as well.

The predominant way of matching metadata schemas is by visual browsing of the schema structures and by using Graphical User Interfaces (GUIs) to indicate the connections between schema elements. Most commercial Extract, Transform, and Load (ETL) tools provide GUIs for this purpose, such as in products from Informatica Corporation, Ascential Software Corporation, International Business Machines Corporation (e.g., CrossWorlds Software®), Oracle Corporation (e.g., Oracle® Developer 9i), etc. Lately, a number of schema matching approaches have evolved in academic literature for database schema matching. The problem of automatically finding semantic relationships between schemas has been addressed by a number of database researchers, for example S. Melnik, H. Gurcia-Malina, and E. Rahm. Similarity Flooding: A Versatile Graph Matching Algorithm and Its Application to Schema Matching, In Proceedings of the 18th International Conference on Data Engineering, pages 117-128, San Jose, Calif., USA, March 2002 (hereinafter “Similarity Flooding” article); J. Madhavan, P. A. Bernstein, and E Rahm, Generic Schema Matching with Cupid, In Proceedings of the 27th International Conference on Very Large Databases, Rome, Italy, September 2001 (hereinafter “Cupid” article); S. Bergamaschi, S. Castano, M. Vincini, and D. Beneventano, Semantic Integration of Heterogeneous Information Sources, Data and Knowledge Engineering, 36(3):215-249, March 2001; W.-S. Li and C. Clifton, SEMINT: A Tool for Identifying Attribute Correspondences in Heterogeneous Databases using Neural Networks, Data and Knowledge Engineering, 33(1):49-84, April 2000; A. Doan, P. Domingos, and A. Y. Halevy, Reconciling Schemas of Disparate Data Sources: A Machine-Learning Approach, In Proceedings of the ACM SIGMOD, Santa Barbara, Calif., USA, May 2001; H.-H. Do and E. Rahm, COMA: A System for Flexible Combination of Schema Matching Approaches, In Proceedings of the 28th International Conference of Very Large Databases, Hong Kong, China, August 2002; A. Doan, J Madhavan, P. Domingos, and A. Halevy, Learning to Map between Ontologies on the Semantic Web, In Proceedings of the Eleventh International World Wide Web Conference, pages 59-66, Hawaii, USA, May 2002; and E. Rahm and P. A. Bernstein; A Survey of Approaches to Automatic Schema Matching, VLDB Journal, 10(4):334-350, 2001.).

More recently, schema matching has been applied to the problem of semantic API matching as in (D. Caragea and T. Syeda-Mahmood, Semantic API Matching for Automatic Service Composition, In Proceedings of the ACM WWW Conference, New York, N.Y., USA, June 2004) and keyword-based schema search (G. Shah and T. Syeda-Mahmood, Searching Databases for Semantically-Related Schemas, In Twenty-Seventh Annual ACM SIGIR, pages 504-505, Sheffield, UK, 25-29, Jul. 2003). The predominant approaches to schema matching compute similarity between schema elements using name and type semantics. The matching is then determined by traversing the schema structure using graph matching methods. Since subgraph matching is an Non-deterministic Polynomial time (NP)-complete problem, this step can be compute-intensive, and most approaches use heuristics to prune the search, such as in the Similarity Flooding article.

While previous work has focused on characterizing pair-wise schema matching, there were two important elements that were not considered adequately. First, the combination of cues (e.g., lexical and semantic similarity in names) was usually done by weighted linear combination, ignoring other combinations possible. Weighted linear combinations assume that all cues are available for matching. Frequently in schema matching, lexical and semantic similarity in names dominate over structural and other ways of capturing similarity unless such information is not present. In that case, straightforward weighting functions that attach higher weight to one cue over the other may not be sufficient. Second, the issue of efficient computation of matching has been largely ignored. Similarity computations are typically performed pair-wise, leading to O(n²) complexity prior to computing the maximum matching, which can be compute-intensive as well. O(x) may be described as providing the order “O” of complexity, where the computation “x” within parenthesis describes the complexity. For example, O(n²) may be described as being the order of quadratic (n²) complexity. This is particularly important in semantic matching where thesaurus lookups take up a fair amount of computation and may result in a large number of matches. For large schemas, it is impractical to use approaches such as that used in the Similarity Flooding article, which involves detailed graph traversal. Most approaches use heuristics to prune the search, such as in the Similarity Flooding article.

Thus, there is a need to improve the efficiency of conventional schema matching techniques to look for matches of attributes. Additionally, there is a need for an improved technique to combine semantic and lexical similarity to perform schema matching.

### SUMMARY

Provided are a method, article of manufacture, and system for semantic matching. A semantic index is created for one or more schemas, wherein each of the one or more schemas includes one or more word attributes, and wherein each of the one or more word attributes includes one or more tokens, wherein the semantic index identifies one or more keys and one or more values for each key, wherein each value specifies one of the one or more schemas, a word attribute from the specified schema, and a token of the specified word attribute, and wherein the specified token is a synonym of the key. For a source word attribute from one of the one or more schemas, the source word attribute is used as a key to index the semantic index to identify one or more matching word attributes.

### BRIEF DESCRIPTION OF THE DRAWINGS

Referring now to the drawings in which like reference numbers represent corresponding parts throughout:

FIG. 1 illustrates details of a computer architecture in accordance with certain embodiments.

FIG. 2 illustrates logic performed by a semantic matching engine for semantic index creation in accordance with certain embodiments.

FIGS. 3A, 3B, and 3C illustrate logic performed by the semantic engine for online processing; in accordance with certain embodiments.

FIG. 4 illustrates a pair of schemas to be matched in accordance with certain embodiments.

FIG. 5 illustrates a semantic index in accordance with certain embodiments.

FIGS. 6A and 6B illustrate a bipartite graph between two schemas, in accordance with certain embodiments.

FIG. 7 illustrates an architecture of a computer system that may be used in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made without departing from the scope of embodiments of the invention.

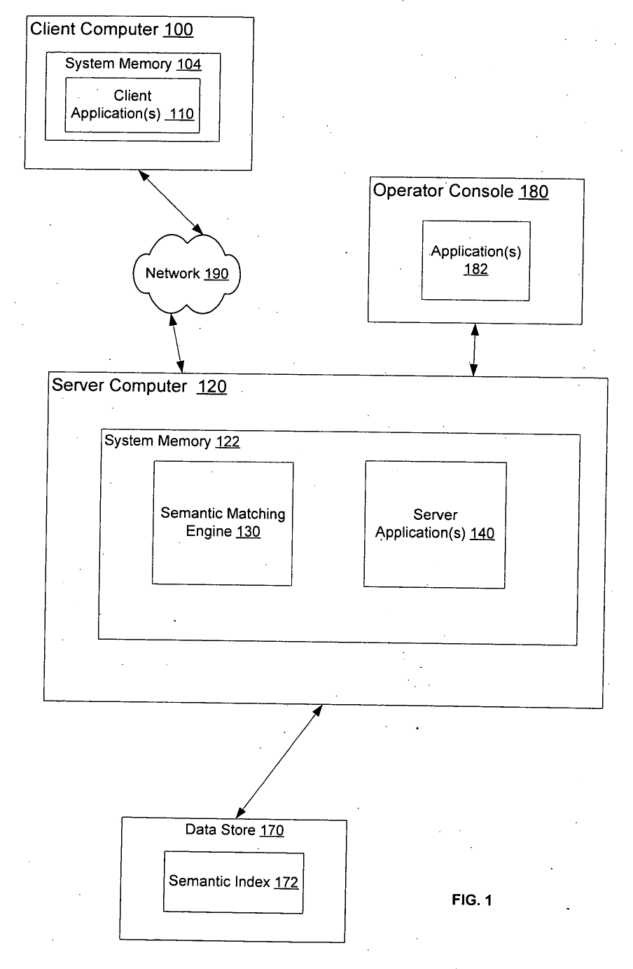

FIG. 1 illustrates details of a computer architecture in accordance with certain embodiments. A client computer 100 is connected via a network 190 to a server computer 120. The client computer 100 includes system memory 104, which may be implemented in volatile and/or non-volatile devices. One or more client applications 110 (i.e., computer programs) are stored in the system memory 104 for execution by a processor (e.g., a Central Processing Unit (CPU)) (not shown).

The server computer 120 includes system memory 122, which may be implemented in volatile and/or non-volatile devices. System memory 122 stores a semantic matching engine 130 and one or more server applications 140. These computer programs that are stored in system memory 122 are executed by a processor (e.g., a Central Processing Unit (CPU)) (hot shown). The server computer 120 provides the client computer 100 with access to data in a data store 170. The data store 170 includes a semantic index 172. In certain embodiments, the semantic index is a semantic hash table or hash map.

In alternative embodiments, the computer programs may be implemented as hardware, software, or a combination of hardware and software.

The client computer 100 and server computer 120 may comprise any computing device known in the art, such as a server, mainframe, workstation, personal computer, hand held computer, laptop telephony device, network appliance, etc.

The network 190 may comprise any type of network, such as, for example, a Storage Area Network (SAN), a Local Area Network (LAN), Wide Area Network (WAN), the Internet, an Intranet, etc.

The data store 170 may comprise an array of storage devices, such as Direct Access Storage Devices (DASDs), Just a Bunch of Disks (JBOD), Redundant Array of Independent Disks (RAID), virtualization device, etc.

Thus, embodiments allow semantic relationships of word attributes to be found between schemas through multi-term words. Also, embodiments are applicable to various matching techniques. Embodiments use an efficient indexing scheme that uses a semantic index to look for matches of word attributes, which speeds up the retrieval of matching word attributes to allow live matching and avoid thesaurus lookup delays.

Embodiments use semantics of names for matching schema elements in an indexing framework. Embodiments construct an overall match by computing a maximum matching in the bipartite graph formed from candidate schemas. Certain embodiments allow matching of a single schema to two or more schemas and vice versa where the schemas may be modeled as a single merged schema. In particular, embodiments construct matches to multi-term words (also referred to as “word attributes”) in schema by using ontological lookups from a domain-independent or domain-dependent ontology, and use the matches to generate a maximum cardinality maximum weight bipartite graph matching. Embodiments combine lexical and semantic matching cues using information derived from the extent of match. Further, embodiments of the invention efficiently compute this matching using a semantic index of names. The term “word attribute” may be used to refer to multi-term words (e.g., DataType or TableData) in the schema that reflect names in schema content rather than tag information. Thus, the operation name in a service is a word attribute, while the word ‘operation’ is considered a tag type.

Finding name semantics between word attributes may be difficult for several reasons. For instance, word attributes may be multi-term words (e.g., CustomerIdentification, PiloneCountry) that require tokenization. The tokenization captures naming conventions used by, for example, database administrators, system integrators, and programmers, to form word attribute names.

The term “query” schema may be used to refer to a schema that is being matched to another schema (also referred to as a “repository” schema), and word attributes in the query schema may be referred to as “query” attributes. Finding meaningful matches to a query attribute accounts for the different senses of the word attribute and accounts for a part-of-speech tag of the word attribute through a thesaurus. Moreover, multiple matches of a single query attribute to many repository attributes (from one or more repository schemas) and multiple matches of a single repository attribute to many query attributes are taken into account.

Embodiments capture name semantics using a technique in which multi-term query attributes are parsed into tokens. Part-of-speech tagging and stop-word filtering is performed. Abbreviation expansion is done for retained words, if necessary, and then a thesaurus is used to find the ontological similarity of the tokens. The resulting synonyms are assembled back to determine matches to candidate word attributes of the repository schemas. Name semantics may also be captured using other techniques (e.g., Madhavan, P. Bernstein, R Chen, A. Halevy, and P Shenoy, Corpus-based Schema Matching, In Proceedings of the Information Integration on the Web, pages 59-66, Acapulco, Mexico, August 2003).

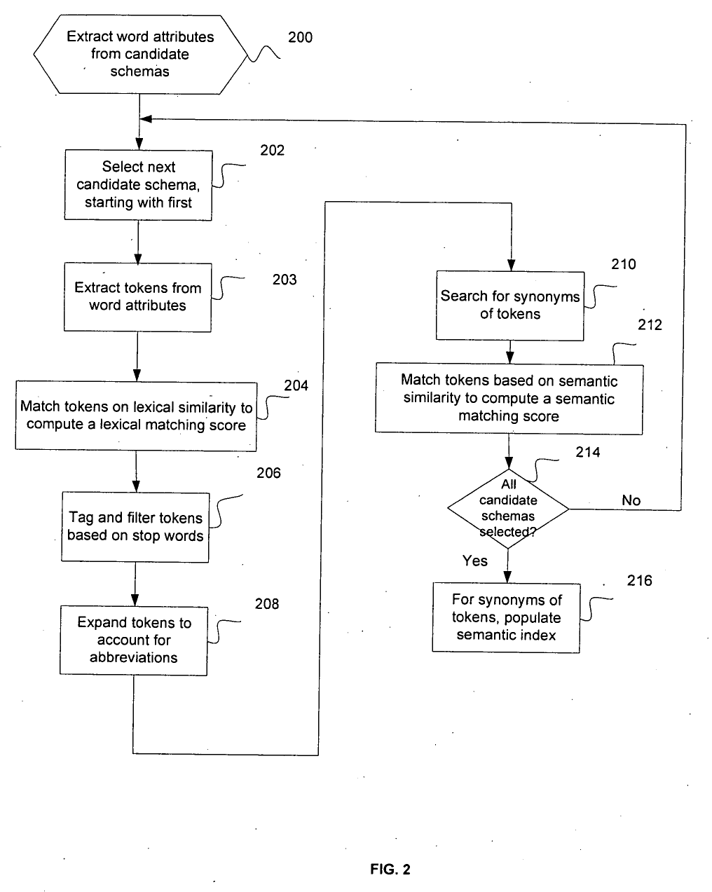

FIG. 2 illustrates logic performed by the semantic matching engine 130 for semantic index creation in accordance with certain embodiments. Control begins at block 200 with the semantic matching engine 130 extracting word attributes from candidate schemas in the data store 170. Different kinds of parsers may be used to extract the word attributes, depending on the type of metadata. The type of schemas may be, for example, schemas for relational tables, XML documents, web services, etc. Word attributes may be described as multi-term words representing schema entities.

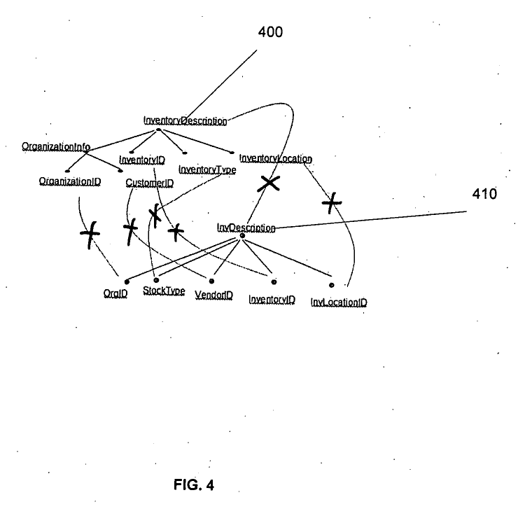

Examples word attributes are shown in FIG. 4, which illustrates a pair of schemas 400, 410 to be matched in accordance with certain embodiments. In FIG. 4, word attributes in the pair of schemas 400, 410 are similar but not identical. For example, the matching schemas 400, 410 may not use exactly the same terms to describe similar word attributes (e.g., OrgID versus OrganizationID, StockType versus InventoryType). To find such similar terms, tokenization and part-of-speech tagging may be performed on the word attributes before thesaurus lookups are performed for synonymous word attributes. Here, the word attributes include leaf-level names (e.g., OrganizationID) and intermediate nodes (e.g., OrganizationInfo). The arrows marked with an “X” (e.g., --X→) show the matching computed by embodiments of the invention.

In block 202, the semantic matching engine 130 selects a next candidate schema, starting with a first. In block 203, the semantic matching engine 130 extracts tokens from the word attributes. This processing may also be described as tokenizing the word attributes and extracting multiple terms. To tokenize the word attributes, embodiments exploit common naming conventions used by programmers and database analysts. In particular, embodiments find word attribute boundaries in a multi-term word using changes in font, presence of delimiters (e.g., underscore and spaces), and numeric to alphanumeric transitions. Thus, a word attribute, such as CustomerPurchase, is separated into Customer and Purchase. Address1, Address2 are separated into Address, 1 and Address, 2 respectively. This allows for semantic matching of the word attributes.

In block 204, the semantic matching engine 130 matches tokens based on lexical similarity (e.g., performs a simple lexical match of the tokens). This generates a lexical match score (LM), which may be generated using Equation (1) below.

$$L ( A , B ) = 2 \cdot \frac{\vert LCS ( A , B )}{\vert A \vert + \vert B \vert} \qquad ( 1 )$$

where A and B are word attributes, and LCS(A, B) is a longest common subsequence of A and B.

The lexical similarity between two tokens may be computed using the length of a longest common subsequence between the two tokens, normalized by the length of the common subsequences. The longest common subsequence may be described as a matching string. The longest common subsequence may be obtained using dynamic programming as described in Thomas H. Cormen, Charles E. Leiserson, and Ronald L. Rivest, Introduction to Algorithms, The MIT Press, 1990. Dynamic programming is based on the idea that an optimal alignment of strings is computed from subalignments that are optimal themselves based on chosen criterion (e.g., longest common subsequence). Dynamic programming is usually implemented by storing the intermediate results of subsolutions and reusing these intermediate results in the overall solution, rather than recomputing the subsolutions, thus trading off memory space for time taken.

In block 206, the semantic matching engine 130 performs part-of-speech tagging and filtering of the tokens based on stop words. Stop words may be described as common words (e.g., words such as a, an, the, etc.) that are ignored because they are not useful for matching word attributes. Simple grammar rules may be used to detect noun phrases and adjectives. Stop-word filtering is performed using, for example, a pre-supplied list. Embodiments may use common stop words in the English language similar to those used in search engines.

In block 208, the semantic matching engine 130 expands the word attributes to account for abbreviations. The abbreviation expansion may use domain-independent, as well as, domain-specific vocabularies. It is possible to have multiple expansions for a candidate word attribute. Such word attributes and their synonyms are retained for later processing. Thus, a word attribute such as CustPurch is expanded into CustomerPurchase, CustomaryPurchase, etc.

Certain embodiments use a thesaurus (e.g., A Miller WordNet: A Lexical Database for the English Language, http://www.cogsci.princeton) to find matching synonyms to word attributes. Or SureWord at (http://www.patternsoft.com/sureword.htm).

In block 210, the semantic matching engine 130 searches for synonyms (e.g., using an ontology to find related terms). That is, a thesaurus is used to find matching synonyms to word attributes. Each synonym is assigned a similarity score based on a sense index (e.g., how close in meaning the synonym is to the original token for which synonyms are being found) and the order of the synonym in the matches returned.

In block 212, the semantic matching engine 130 matches tokens based on semantic similarity. For match generation, consider a pair of candidate matching word attributes (A, B) from the query and repository schemas respectively. For this example, it is assumed that candidate matching word attributes A and B have m and n valid tokens, respectively, and S_{yi} and S_{yj} are their expanded synonym lists, respectively, based on ontological processing. Embodiments consider each token “i” in source word attribute A to match a token j in destination word attribute B if i ε S_{yi} or j ε S_{yj}. The semantic similarity (i.e., semantic match score (SM)) between word attributes A and B is then given by Equation (2). This generates a semantic match score (SM), which may be generated using Equation (2):

$$Sem ( A , B ) = 2 \cdot \frac{Match ( A , B )}{m + n}$$

where Match(A, B) are the matching tokens and m and n are valid tokens of word attributes A and B, respectively.

The semantic similarity measure allows matching of word attributes, such as (state and province), (CustomerIdentification and ClientID), (CustomerClass and ClientCategory), etc.

In block 214, the semantic matching engine 130 determines whether all candidate schemas have been selected. If so, processing continues to block 216, otherwise, processing loops back to block 202 and another candidate schema is selected.

In block 216, for the synonyms of the tokens, the semantic matching engine 130 populates a semantic index indexed by the synonyms. Each entry in the semantic index provides information in the form of a schema, a word attribute, and a token for every token for which a given key is the synonym.

The semantic indexing scheme allows determination of valid edges of the bipartite graph to allow faster matching. During an off-line index creation stage, a semantic index is created for two or more schemas.

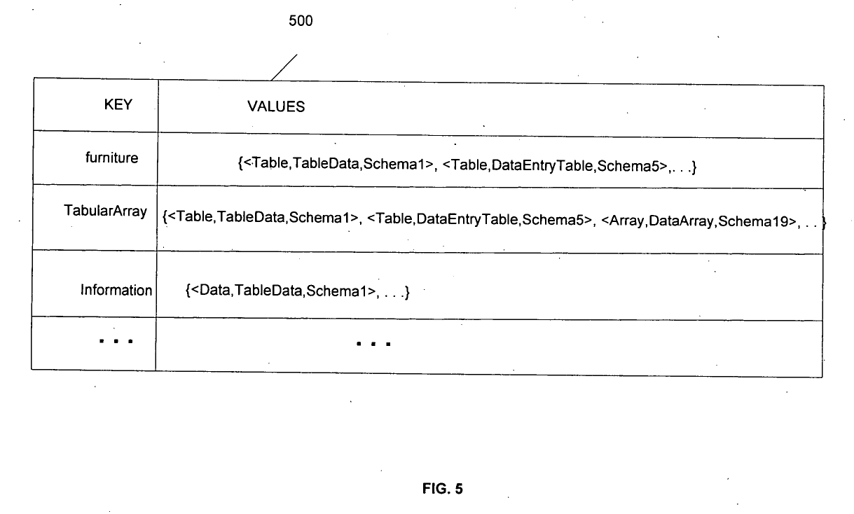

FIG. 5 illustrates a semantic index 500 in accordance with certain embodiments. The semantic index 500 includes keys and values associated with the keys. Synonyms of tokens of one or more schemas are used as the keys. For example, in the semantic index 500, for a key “furniture”, a corresponding entry may be <Table,TableData,Schema1>, which indicates that “furniture” is a synonym of the token “Table” from word attribute “TableData”, which is from “Schema1”. Similarly, “furniture” is also a synonym of another token, also of the name “Table”, that belongs to the word attribute “DataEntryTable” from Schema 5 (as illustrated by the entry <Table,DataEntryTable,Shema5>).

To perform schema matching, when a word attribute, such as “TabularArray” is retrieved from a schema, then “TabularArray” is used as a key into the semantic index 500. The result is that the word attribute “TabularArray” is found to by a synonym for, and, thus, match, the word attribute “TableData” from “Schema1”, the word attribute “DataEntryTable” from “Schema5”, and the word attribute “DataArray” from “Schema19”, each of which now matches fifty percent (50%) of the word attribute ‘TabularArray’ (i.e., the matching token is Table from each of the above matching word attributes).

Thus, to create an off-line semantic index, a schema format is parsed to create schemas. Embodiments may use different parsers based on the metadata types. For example, embodiments may use an Eclipse Modeling Framework (EMF)-model for XML Schema Definition (XSD) schemas to process XSD schemas. An EMF-model is a tool that takes a description of a model (e.g., an XSD schema) and generates code for an object oriented software model. XSD specifies how to describe the elements in an Extensible Markup Language (XML) document. For web services, embodiments use a similar EMF-based parser to extract data from a Web Services Description Language (WSDL) file as a WSDL schema. WSDL is an XML format for describing network services as a set of endpoints operating on messages containing either document-oriented or procedure-oriented information. Relational schemas may be similarly processed using a relational EMF model. The details of XSD, WSDL and relational schema specifications are described further in: XML Schema Definition (XSD) (available at http://www.w3.org/XML/Schema.html) and Web Services Description Language (available at http:/www.w3.org/TR/wsdI).

To generate the schema from web services, embodiments define each node as a tag type. The root is the name of the service, and the next level represents portTypes. Child nodes of each portType correspond to operations. The parent-child relationship is determined by the scope of the tag. Thus, an operation has input and output messages as child nodes, while messages have parts as child nodes.

The parsers used to extract the schemas may also be used to extract word attributes along with their tag types. Embodiments then separate multiple terms in each word attribute into tokens, perform part-of-speech tagging, perform word expansion, and derive synonyms per token by using, for example, a thesaurus. The synonyms are used as keys into the semantic index. In certain embodiments, the semantic index records the following tuple per indexed entry: <(tᵢ, wⱼ, tyⱼ, Sₖ)> where tᵢ is the index of the token, wⱼ the word attribute from which the token is derived, tyⱼ is the tag type of the word attribute, and Sₖ is the schema from which the word attribute was extracted.

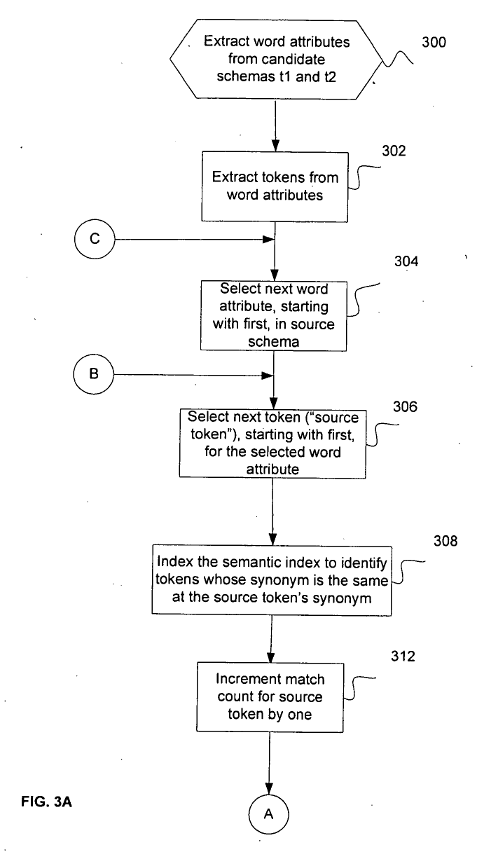

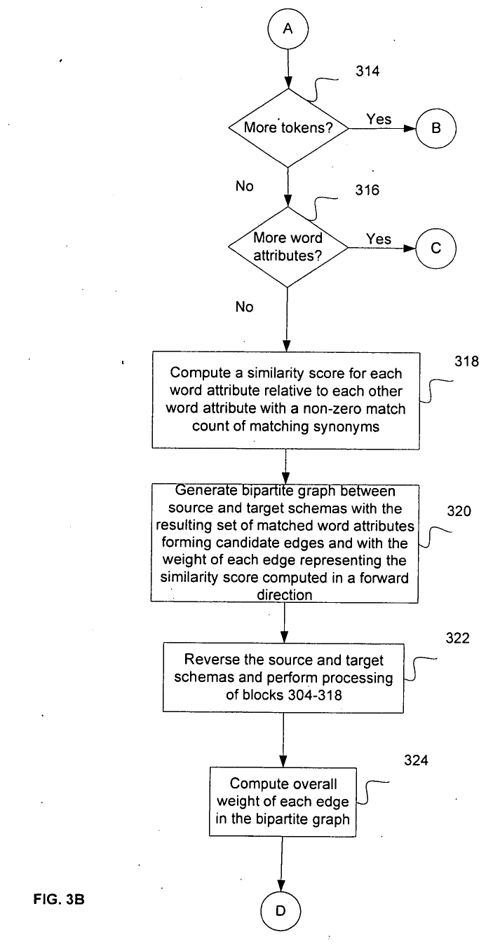

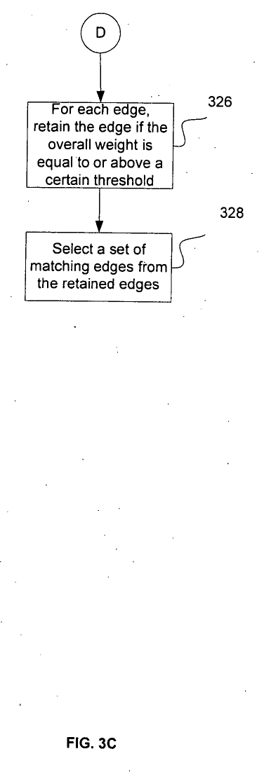

FIGS. 3A, 3B, and 3C illustrate logic performed by the semantic engine for online processing, in accordance with certain embodiments. That is, given a pair of schemas, the semantic matching engine 130 defines matches. Control begins at block 300 with the semantic matching engine 130 extracting word attributes from candidate schemas, S1 and S2. In block 302, the semantic matching engine 130 extracts tokens from word attributes from the candidate schemas. In block 304, the semantic matching engine 130 selects the next word attribute w_{q} (“source word attribute”), starting with the first, in source schema (e.g., S1). In particular, one schema is labeled as a “source” schema, and the other schema is labeled as a “target” schema. In block 306, the semantic matching engine 130 selects the next token (“source token”) for the selected word attribute, starting with the first. In block 308, the semantic engine indexes the semantic index with the tokens of the candidate word to identify tokens that are synonyms of the current token. In particular, let <t_{i},w_{j),S_{k}> identify tokens which are synonyms of the source token. In block 312, the semantic matching engine 130 increments a match count, Match(w_{q},w_{j}), by one (1) to indicate that one more tokens from the respective source and target word attributes have matched. From block 312, processing continues to block 314 of FIG. 3B.

In block 314 (of FIG. 3B), the semantic matching engine 130 determines whether there are more tokens for the selected word attribute. If so, processing continues to block 306 (of FIG. 3A) to select another token, otherwise, processing continues to block 316. In block 316, the semantic matching engine 130 determines whether there are more word attributes for the source schema. If so, processing continues to block 304 (of FIG. 3A) to select the next word attribute, otherwise, processing continues to block 318.

In block 318, the semantic matching engine 130 computes a similarity score for each word attribute relative to each other word attribute with a non-zero match count of matching synonyms. In particular, the score of w_{q} to each w_j} is computed as: Score(w_{q},w_{j})=2 Match(w_{q},w_{j})/(|w_{q}|+|w_{ }|).

In block 320, the semantic matching engine 130 generates a bipartite graph between the source and target schemas (S1 and S2) with the resulting set of matched word attributes forming candidate edges and with the weight of each edge representing the similarity score computed in a forward direction.

In block 322, the semantic matching engine 130 reverses the source and target schemas (i.e., schema S1 becomes the target schema and schema S1 becomes the source schema) and performs the processing of blocks 304-318. This defines a similarity score for the edge w_{j}=>w_{q} in a backward direction (e.g., from schema S2 to schema S1). In block 324, the semantic matching engine 130 computes the overall weight of each edge in the bipartite graph as weight (w_{q},w_{j})=min(score(w_{q},w_{j}), score(w_{j},w_{k})), where “min” means minimum. From block 324, processing continues to block 326 of FIG. 3C. In block 326 (of FIG. 3C), for each edge, the semantic matching engine 130 retains the edge if the overall weight of the edge (w_{q},w_{j}) is equal to or above a certain threshold T. For example, for a threshold T=⅔ (two thirds), the semantic matching engine 130 ensures that at least two thirds (⅔rds) of the tokens in the candidate word attributes match in order to identify the word attributes as similar. In block 328, the semantic matching engine 130 selects a set of matching edges from the retained edges. In particular, a set of matching edges is retained using one or more techniques of computing a maximum matching. For example, the following techniques may be used: greedy matching, stable marriage, maximum cardinality matching, or maximum cardinality matching of maximum weight. For greedy matching, the edges are sorted by weight and picked from a highest weight until no more source or target nodes are left. For stable marriage, source and target nodes that are matched are equal in number, so that for each source node there is a matching target node and vice versa. For maximum cardinality matching, a network flow technique is used. For maximum cardinality matching of maximum weight, a cost-scaling techniques is used (e.g., A. Goldberg and Kennedy, An Efficient Cost-Scaling Algorithm for the Assignment Problem, SIAM Journal on Discrete Mathematics, 6(3):443-459, 1993, hereinafter “Cost-Scaling” article).

In certain embodiments, the processing of block 328 uses greedy matching. For greedy matching, the semantic match score and the lexical match score (SM,LM) are used to sort the matches word attributes for selecting the edges in the bipartite graph. In such embodiments, the semantic match of names is weighted more than the lexical match of names, unless the semantic match is not possible, in which case the lexical match dominates. This type of combination of cues reduces the fixed weight bias for combining cues. In alternative embodiments, the higher score is used for sorting from among the semantic match score and lexical match score.

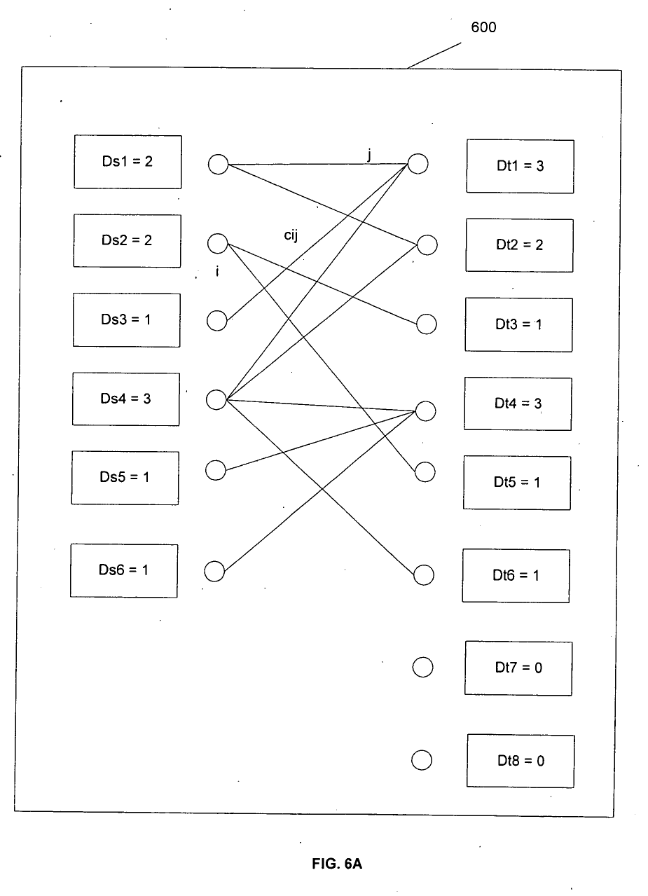

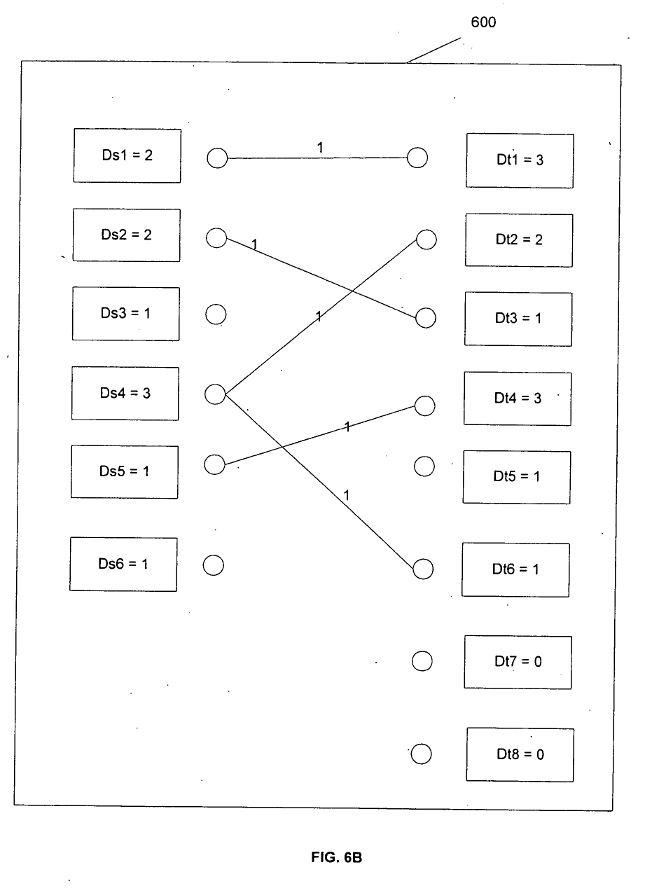

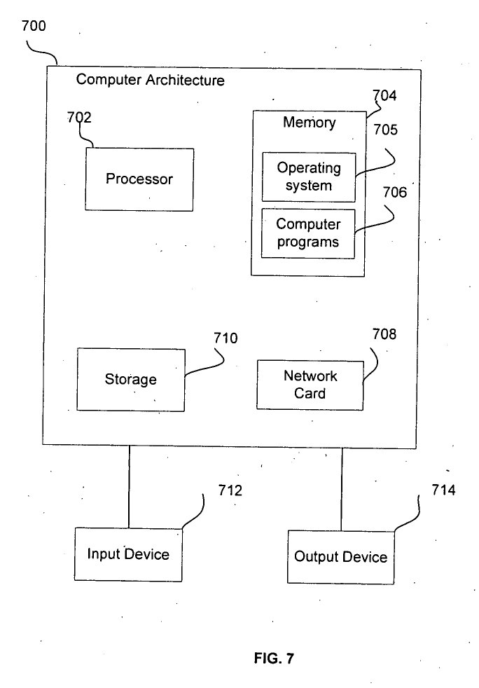

FIGS. 6A and 6B illustrate a bipartite graph between two schemas, in accordance with certain embodiments. FIG. 6A illustrates an original bipartite graph 600 with all matching edges in accordance with certain embodiments. FIG. 6B illustrates a maximum matching for the bipartite graph 600 in accordance with certain embodiments.

More formally, consider a bipartite graph G=(V=X U Y, E, C) where X ε Q and Y ε D are word attributes in source and target schemas, Q and D, respectively, E are the edges defining possible relationships between word attributes, and C:E→R are the similarity scores representing similarity between query and schema word attributes per edge. In this formalism, it is assumed than an edge is drawn between two word attributes if they are semantically related. A matching M ⊂ E is a subset of edges in E such that each node appears at most once. The size of the matching is indicated by |M|. For each repository schema, the desired matching is a matching of maximum cardinality |M| that also has the maximum similarity weight is given by Equation (3):
C(M)=ΣC(Eᵢ) (3)
where C(Eᵢ) is the similarity between the word attributes related by the edge Eᵢ.

Thus, once the schemas are processed to create their respective semantic indexes, the tokens are directly used to find matches. This gives closer matches than the matches obtained by looking up synonyms of synonyms. The resulting source tuples are denoted by <(tₗ, qₘ, tyₘ)>, where tₗ is the l-th tuple in m-th source word attribute qₘ, and tyₘ, is the type tag associated with source word attribute qₘ.

As for complexity analysis, if there are Nᵢ word attributes per schema i, tₖ tokens per word, and Syᵢ synonyms per token, then the time complexity of index creation is quadratic complexity as illustrated by

$$O ( {\sum }_{k - 1}^{{N}_{i}} {\sum }_{l = 1}^{{t}_{k}} {S}_{{y}_{l}} ) .$$

Since the number of tokens per word is small (e.g., <=5) and there are roughly 30 synonyms per word in many cases, the dominant term in the indexing complexity are illustrated by

$${\sum }_{k = 1}^{{N}_{i}} .$$

In certain embodiments, on a one gigabyte (1 GB) Random Access Memory (RAM) machine, the entire database index for 570 schemas may be assembled in four minutes. The size of the semantic hash table depends on the number of synonyms and the number of words that are common across schemas. For certain database sizes that have been tested (approximately 980 schemas), the semantic hash table implemented as a hash map may be stored in memory itself. However, as the size of the database grows, database index storage structures may be used. The complexity during online processing is O(|Q|.|N|), where N_{Q} represents the number of tuples indexed per query word. For the databases tested, the search took fractions of seconds per query.

Embodiments provide techniques for matching semantically-related schemas derived from a variety of metadata sources, including web services, XML Schema Definition (XSD) documents, and relational tables. XSD documents specify how to formally describe the elements in an XML document. Embodiments compute a maximum matching in the pairwise bipartite graphs formed from schema word attributes (e.g., query and repository word attributes). The edges of the bipartite graph capture the semantic similarity between corresponding word attributes in the schemas based on their name semantics.

Embodiments match schemas in XML repositories. Such schemas are available in many practical situations, either as skeletal designs made by analysts while looking for matching services or obtained from another database source (e.g., data warehousing). Although examples (e.g., of pseudocode or experiments) herein may refer to XML schemas, embodiments may be applied to any kind of repository (e.g., any type of relational database).

Embodiments find matching schemas from repositories by computing a maximum matching in pairwise bipartite graphs formed from schema word attributes (e.g., query and repository attributes). The edges of the bipartite graph capture the similarity between corresponding word attributes in the schema. To ensure meaningful matches, and to allow for situations where schemas use related but not identical word attributes to describe related entities, name semantics are used in modeling similarity between word attributes.

The techniques provided by embodiments for matching XML schemas was tested on two large repositories. The first one was a business object repository consisting of 517 application-specific and generic business objects. The second repository was generated from 473 WSDL documents assembled from legacy applications, such as COBOL copybooks. Each of the schemas was rather large, containing 100 or more word attributes, particularly, because of schema embedding through imports in web services or XSD documents, so that the fully-expanded schemas were rather large. Embodiments present the results for the XSD schemas merely to enhance understanding of embodiments.

The second technique that was implemented illustrates the power of semantic search techniques over lexical match techniques. In these embodiments, the indexing and search schemas were kept the same, but the semantic name similarity computation was replaced with a lexical similarity measure. Specifically, the extracted words from the schemas are not tokenized or word-expanded. Instead they are directly compared with repository word attributes to compute a lexical match score (LM) using the above Equation (1).

Intel and Pentium are registered trademarks or common law marks of Intel Corporation in the United States and/or other countries. Oracle is a registered trademark or common law mark of Oracle Corporation in the United States and/or other countries. CrossWorlds Software and CrossWorlds is a registered trademark or common law mark of International Business Machines Corporation in the United States and/or other countries.

### Additional Embodiment Details

The described operations may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals or light propagating through space, radio waves, infrared signals, optical signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of embodiments of the invention, and that the article of manufacture may comprise any information bearing medium known in the art.

Certain embodiments may be directed to a method for deploying computing infrastructure by a person or automated processing integrating computer-readable code into a computing system, wherein the code in combination with the computing system is enabled to perform the operations of the described embodiments.

The term logic may include, by way of example, software or hardware and/or combinations of software and hardware.

The logic of FIGS. 2, 3A, 3B, and 3C describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIGS. 2, 3A, 3B, and 3C may be implemented in software, hardware, programmable and non-programmable gate array logic or in some combination of hardware, software, or gate array logic.

FIG. 6 illustrates an architecture 600 of a computer system that may be used in accordance with certain embodiments. Client computer 100, server computer 60, and/or operator console 180 may implement architecture 600. The computer architecture 600 may implement a processor 602 (e.g., a microprocessor), a memory 604 (e.g., a volatile memory device), and storage 610 (e.g., a non-volatile storage area, such as magnetic disk drives, optical disk drives, a tape drive, etc.). An operating system 605 may execute in memory 604. The storage 610 may comprise an internal storage device or an attached or network accessible storage. Computer programs 606 in storage 610 may be loaded into the memory 604 and executed by the processor 602 in a manner known in the art. The architecture further includes a network card 608 to enable communication with a network. An input device 612 is used to provide user input to the processor 602, and may include a keyboard, mouse, pen-stylus, microphone, touch sensitive display screen, or any other activation or input mechanism known in the art. An output device 614 is capable of rendering information from the processor 602, or other component, such as a display monitor, printer, storage, etc. The computer architecture 600 of the computer systems may include fewer components than illustrated, additional components not illustrated herein, or some combination of the components illustrated and additional components.

The computer architecture 600 may comprise any computing device known in the art, such as a mainframe, server, personal computer, workstation, laptop, handheld computer, telephony device, network appliance, virtualization device, storage controller, etc. Any processor 602 and operating system 605 known in the art may be used.

The foregoing description of embodiments has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the invention, the embodiments reside in the claims hereinafter appended or any subsequently-filed claims, and their equivalents.

What is claimed is:

1. A method for semantic matching of, comprising:
creating a semantic index for one or more schemas, wherein each of the one or more schemas includes one or more word attributes, and wherein each of the one or more word attributes includes one or more tokens, wherein the semantic index identifies one or more keys and one or more values for each key, wherein each value specifies one of the one or more schemas, a word attribute from the specified schema, and a token of the specified word attribute, and wherein the specified token is a synonym of the key; and
for a source word attribute from one of the one or more schemas, using the source word attribute as a key to index the semantic index to identify one or more matching word attributes.

2. The method of claim 1, wherein creating the semantic index further comprises:
extracting each of the one or more word attributes from the one or more schemas; and
for each of the one or more schemas,
extracting the one or more tokens from each of the one or more word attributes;
tagging and filtering the one or more tokens based on stop words;
expanding the one or more tokens to account for abbreviations; and
searching for synonyms of the one or more tokens.

3. The method of claim 2, wherein the one or more schemas comprise a first schema and a second schema and further comprising:
generating a bipartite graph between the first schema and the second schema with a set of matched word attributes forming candidate edges, and with a weight of each of the candidate edges representing a similarity score computed in a forward direction.

4. The method of claim 3, further comprising:
computing a similarity score for each of the candidate edges in a backward direction.

5. The method of claim 4, further comprising:
computing an overall weight of each of the candidate edges in the bipartite graph.

6. The method of claim 5, further comprising:
for each of the candidate edges, retaining that candidate edge if the overall weight of that candidate edge is equal to or above a certain threshold.

7. The method of claim 6, further comprising:
selecting a set of matching edges from the retained candidate edges.

8. The method of claim 1, wherein the one or more schemas comprise a first schema and a second schema and further comprising:
computing a semantic match score for each pair of word attributes in the first schema and in the second schema.

9. The method of claim 8, further comprising:
computing a lexical match score for each said pair of word attributes in the first schema and in the second schema.

10. The method of claim 9, further comprising:
generating a bipartite graph between the first and second schemas with a set of matched word attributes forming edges; and
sorting edges in the bipartite graph using the semantic match score and the lexical match score.

11. An article of manufacture for semantic, wherein the article of manufacture comprises a computer readable medium storing instructions, and wherein the article of manufacture is operable to:
create a semantic index for one or more schemas, wherein each of the one or more schemas includes one or more word attributes, and wherein each of the one or more word attributes includes one or more tokens, wherein the semantic index identifies one or more keys and one or more values for each key, wherein each value specifies one of the one or more schemas, a word attribute from the specified schema, and a token of the specified word attribute, and wherein the specified token is a synonym of the key; and
for a source word attribute from one of the one or more schemas, use the source word attribute as a key to index the semantic index to identify one or more matching word attributes.

12. The article of manufacture of claim 11, wherein the article of manufacture is operable to:
extract each of the one or more word attributes from the one or more schemas; and
for each of the one or more schemas,
extract the one or more tokens from each of the one or more word attributes;
tag and filter the one or more tokens based on stop words;
expand the one or more tokens to account for abbreviations; and
search for synonyms of the one or more tokens.

13. The article of manufacture of claim 12, wherein the one or more schemas comprise a first schema and a second schema and wherein the article of manufacture is operable to:
generate a bipartite graph between the first schema and the second schema with a set of matched word attributes forming candidate edges, and with a weight of each of the candidate edges representing a similarity score computed in a forward direction.

14. The article of manufacture of claim 13, wherein the article of manufacture is operable to:
compute a similarity score for each of the candidate edges in a backward direction.

15. The article of manufacture of claim 14, wherein the article of manufacture is operable to:
compute an overall weight of each of the candidate edges in the bipartite graph.

16. The article of manufacture of claim 15, wherein the article of manufacture is operable to:
for each of the candidate edges, retain that candidate edge if the overall weight of that candidate edge is equal to or above a certain threshold.

17. The article of manufacture of claim 16, wherein the article of manufacture is operable to:
select a set of matching edges from the retained candidate edges.

18. The article of manufacture of claim 11, wherein the one or more schemas comprise a first schema and a second schema and wherein the article of manufacture is operable to:
compute a semantic match score for each pair of word attributes in the first schema and in the second schema.

19. The article of manufacture of claim 18, wherein the article of manufacture is operable to:
compute a lexical match score for each said pair of word attributes in the first schema and in the second schema.

20. The article of manufacture of claim 19, wherein the article of manufacture is operable to:
generate a bipartite graph between the first and second schemas with a set of matched word attributes forming edges; and
sort edges in the bipartite graph using the semantic match score and the lexical match score.

21. A system for semantic matching, comprising:
logic capable of causing operations to be performed, the operations comprising:
creating a semantic index for one or more schemas, wherein each of the one or more schemas includes one or more word attributes, and wherein each of the one or more word attributes includes one or more tokens, wherein the semantic index identifies one or more keys and one or more values for each key, wherein each value specifies one of the one or more schemas, a word attribute from the specified schema, and a token of the specified word attribute, and wherein the specified token is a synonym of the key; and
for a source word attribute from one of the one or more schemas, using the source word attribute as a key to index the semantic index to identify one or more matching word attributes.

22. The system of claim 21, wherein the operations for creating the semantic index further comprise:
extracting each of the one or more word attributes from the one or more schemas; and
for each of the one or more schemas,
extracting the one or more tokens from each of the one or more word attributes;
tagging and filtering the one or more tokens based on stop words;
expanding the one or more tokens to account for abbreviations; and
searching for synonyms of the one or more tokens.

23. The system of claim 22, wherein the one or more schemas comprise a first schema and a second schema and wherein the operations further comprise:
generating a bipartite graph between the first schema and the second schema with a set of matched word attributes forming candidate edges, and with a weight of each of the candidate edges representing a similarity score computed in a forward direction.

24. The system of claim 23, wherein the operations further comprise:
computing a similarity score for each of the candidate edges in a backward direction.

25. The system of claim 24, wherein the operations further comprise:
computing an overall weight of each of the candidate edges in the bipartite graph.

26. The system of claim 25, wherein the operations further comprise:
for each of the candidate edges, retaining that candidate edge if the overall weight of that candidate edge is equal to or above a certain threshold.

27. The system of claim 26, wherein the operations further comprise:
selecting a set of matching edges from the retained candidate edges.

28. The system of claim 21, wherein the one or more schemas comprise a first schema and a second schema and wherein the operations further comprise:
computing a semantic match score for each pair of word attributes in the first schema and in the second schema.

29. The system of claim 28, wherein the operations further comprise:
computing a lexical match score for each said pair of word attributes in the first schema and in the second schema.

30. The system of claim 29, wherein the operations further comprise:
generating a bipartite graph between the first and second schemas with a set of matched word attributes forming edges; and
sorting the edges in the bipartite graph using the semantic match score and the lexical match score.
